(19) United States
(12) Patent Application Publication
(10) Pub. No.: US 2019/0171997 A1
(43) Pub. Date: Jun. 6, 2019

(54) Systems and Methods for Product Expiration Date Management

(71) Applicant: C. Rachelle Roach, Clearwater, FL (US)

(72) Inventor: C. Rachelle Roach, Clearwater, FL (US)

(21) Appl. No.: 15/829,855

(22) Filed: Dec. 1, 2017

(51) Int. Cl. G06Q 10/08; G08B 21/18

(52) U.S. Cl. CPC G06Q 10/087; G06K 19/06028; G08B 21/182

(57) ABSTRACT

Provided is a method of monitoring the expiration date of an item to enable processing of the item prior to the expiration date of the item. The item has a label having expiration date data located thereon. The expiration date data from the label is in electronic communication with a database. The database of expiration dates can be accessed by a user through an electronic device for monitoring. A programmer programs each item to have a predetermined date range that is a time prior to the item's expiration date. An alert message is activated and is visible to a user through an electronic device when an item's expiration date falls within the predetermined date range. The alert message prompts a user to process the item in preparation for a rapid sale or for a return to the manufacturer during the predetermined date range from the item's expiration date.

### BACKGROUND OF THE INVENTION

### 1. Field of the Invention

This invention relates, generally, to a method of monitoring an expiration date of a product. More particularly, it relates to a product tracking system having a database of items with their associated expiration dates and being configured to communicate the monitored expiration dates to a user for product processing prior to the point-of-sale.

### 2. Background Art

In today's product packaging industry, many packaged products utilize labels with GS1 DataBar Expanded bar codes with identifying information such as weight or an expiration date. These bar codes can be read omni-directionally at the point-of-sale. At the point-of-sale, when the barcode is scanned, an item having an approaching expiration date or a current expiration date will signal to the register screen a message to offer a reduced price or an alert to prevent the sale. There are a number of problems arising with alerting a user such as, a buyer or a seller, of an expired product or of an approaching expiration date at the time of a point-of-sale.

The first problem with alerting a user of an expired product at a point-of-sale is the waste generated from the required disposal of the expired products as seen in industries including, but not limited to, food, wholefoods, nutraceuticals, homeopathics, herbs, cosmetics, dietary supplement, vitamin, beverage, pet food, aviation, military, medical, or pharmaceutical. Many companies are required to throw away massive amounts of expired product. When the product is thrown away, it contributes to the excessive levels of today's environmental waste and could negatively influence global warming. It is more desirable for a product to be used for its intended purpose prior to its expiration date rather than being thrown away at or after a product's expiration date. Thus, there is a need for a novel method for monitoring and alerting a user such as, a distributor or a seller, of an approaching expiration date of a product for efficient and expedited processing such as implementing aggressive marketing strategies for a quick sell or for preparing the product to be returned to the manufacturer for a credit prior to its expiration date.

A second problem with alerting a user of an expired product at a point-of-sale can arise when an expired product is thrown away by a seller or when a product with an approaching expiration date is sold at a reduced cost. Being alerted at the point-of-sale of the expiration of a product is too late for a seller to recover any monetary loss associated with the product expiration. As a result, the seller loses money from product that did not sell at full value, at partial value, or may not have been sold at all. When these companies lose money, the loss is passed on to the consumers who in turn pay a premium to offset the costs associated with the monetary losses of the expired product. It would be more desirable for a seller to be notified in advance of a product expiring so the product can be processed for expedited distribution or be processed for return to the manufacturer for a credit. This efficient product processing will eliminate waste associated with the mass disposal of expired product and will substantially eliminate monetary loss associated with unrecovered produce value. Thus, a novel monitoring system capable of alerting a user of a product expiration date during a predetermined date range prior to the point-of-sale is needed to help maintain profit of a product for a seller and to help keep consumer product cost down from not having to absorb the monetary loss of an unsold, expired product.

Consumer health and safety is another concern when expired products may lose their effectiveness or become toxic. Currently, shelved products are manually organized on store shelves. Employees are responsible for visually reviewing product labels, identifying expired products, and removing expired products from circulation. Human error gives rise to the potential that a consumer may inadvertently purchase and consume an expired product. This may lead to consumer sickness or even death. Further, visual monitoring requires increased labor costs associated with an employee spending hours sifting through products on store shelves. There is a need for a quicker and a more efficient way to monitor, identify, and remove expired products. Thus, a novel monitoring system for product expiration dates will eliminate the human error associated with visual monitoring of these expired products and will greatly reduce the risk of a consumer purchasing an expired product.

However, in view of the prior art considered as a whole at the time the present invention was made, it was not obvious to those of ordinary skill in the pertinent art how the identified needs could be fulfilled.

### SUMMARY OF THE INVENTION

The long-standing but heretofore unfulfilled need for a method of monitoring the expiration date of an item to enable processing of the item prior to the expiration date of the item. The item has a label having expiration date data located thereon. The expiration date data from the label is in electronic communication with a database. The database of expiration dates is in communication with an application program that can be accessed by a user through an electronic device for monitoring. A programmer programs each item to have a predetermined date range that is a date prior to the item's expiration date. An alert message is activated and is visible to a user through an electronic device when an item's expiration date falls within the predetermined date range. The alert message prompts a user to process the item in preparation for a rapid sale or for a return to the manufacturer during the predetermined date range from the item's expiration date which also includes improvements that overcome the limitations of prior art methods of monitoring product expiration dates is now met by a new, useful, and non-obvious invention. It is within the scope of this invention for a rapid sale to include, but not be limited to, a reduced sale price of the item, whereby, a consumer would be more inclined to purchase an item having an upcoming expiration date or an expired expiration date if the item was of a lower than retail cost.

The invention includes a method of monitoring the expiration date of an item to enable processing of the item prior to the expiration date of the item. The item can have a label or packaging having an expiration date located thereon. The item is provided with packaging having an expiration date located thereon. It is within the scope of this invention for packaging to include any surface capable of having an expiration date located thereon including, but not limited to, an item's packaging such as a box, a bag, a wrapper, a container, or a bottle, an adhesive sticker, a label, or the item itself. The expiration date may be printed directly onto an item or may be printed or embossed onto a separate label which is the affixed to the item, or may be printed or embossed onto packaging of an item. It is within the scope of this invention for the novel method of monitoring an expiration date to include any of the aforementioned configurations. It is within the scope of this invention for an item to include, but not be limited to, any perishable, prepackaged, canned, bottled, or prepared product include, but not be limited to, food, wholefoods, nutraceuticals, homeopathics, herbs, cosmetics, a dietary supplement, a vitamin, a beverage, pet food, aviation supplies, military supplies, medical supplies, pharmaceutical supplies, drugs, compressed gas, or marine supplies.

An application program is provided and is capable of comparing the expiration date of the item with a predetermined date preceding said expiration date. The application program is in electrical communication with an electronic device. The application program is adapted to receive input by a user through the electronic device. The input can be the first date (expiration date) or the second date (predetermined date that precedes the expiration date). The predetermined date can be a range of dates or a single date that precedes the expiration date of the item. For example, in a preferred embodiment, a programmer can input into the application program a predetermined date range that is between 3-6 months prior to the expiration date of the item to receive alerts. In a preferred embodiment, the predetermined date of 3 months preceding the expiration date would give the seller ample time to prepare the item for expedited processing including, but not limited to, offering for sale at a discounted cost, relocating the item to a more favorable location in the store for a quicker sell, orienting the item to be subsequently sold out of turn for a quicker sale, reduced sale price, orienting the item to be sold immediately following the alert, or preparing the item for return to the manufacturer for full or partial credit reimbursement.

In a preferred embodiment, a user inputs a first date being the expiration date of the item into the novel expiration date monitoring application program. There may be instances when a product is prepackaged by the manufacturer and has a barcode and a separate expiration date. When the expiration date is not in communication with the barcode, an expiration date database does not exist and a user will have to manually input the expiration date data into the novel expiration date monitoring application program. Additionally, when an expiration date labeled into a product is not in electrical communication with a database, a user will need to manually input the expiration date data into the novel expiration date monitoring application program.

In another step, a user inputs a second date being the predetermined date that precedes the first date of the item into the application program. The predetermined date is configured to be determined by a user. It is within the scope of this invention for a user to include, but not be limited to a programmer, a seller, a quality control specialist, a loss prevention specialist, an employee, or any individual capable of monitoring expiration dates of an item. The application program allows a user to monitor the second date as it relates to the first date of the item. The application program can be accessed by a user through an electronic device including, but not limited to a tablet, a computer, a phone, wired or wireless connection, a smart phone, or an iPad. The application generates an alert message when the second date is met. The alert message indicates to a user when the second date is met. In an alternate embodiment, it is within the scope of this invention for a third date or a fourth date being entered into the application program by a user to correspond to another predetermined date that precedes the first date of the item. This would allow for multiple alert messages corresponding with multiple predetermined dates preceding the first expiration date.

This is a crucial step in this novel method of monitoring expiration dates of an item because it is at this instant point in time when a user is going to attempt to maximize the gain associated with selling the item prior to the item's expiration date or minimizing the monetary loss associated with preparing impending expired item for return to the manufacturer for reimbursement. Rather than letting an unmonitored item go to waste and become expired without taking action, a stimulus, being the alert message is going to prompt a response for action upon the item. It is a preferred embodiment of this current invention for this alert message to be viewable to a user prior to the point-of-sale, to allow plenty of time to quickly sell this item out of turn in comparison with other items not having an impending expiration date being met or at the second date inputted into the application program.

When a user detects the alert message of the application program, which may be directly emailed or texted to a user, or can be viewable within the application program item status page, the user will be prompted to take immediate action. This immediate action prompts a user to expedite the processing of the item when an alert message is detected. The alert message is adapted to urge a user to move an item from inventory prior to the first date entered into the application program associated with a specific item. It is within the scope of this invention for moving an item to include, but not be limited to, implementing an aggressive marketing strategy of the item for a quick sale, re-shelving the item to a more desirable location, prioritizing the item to be sold out of turn before any other related product, removing the item from a retail store front for expedited online selling, removing the item from a retail store front for return to a manufacturer.

A user is prompted to process the item indicated in the alert message prior to the first date of the item, which is the item's expiration date. The item is associated with a transaction prior to the first date of the item as inputted into the application program. So, before the item's expiration date occurs, the item must have undergone a transaction. This will completely eliminate a seller acquiring unsold expired items because the items would have been sold prior to the expiration date of the item or the item may have been returned to the manufacturer prior to the item's expiration date. It is within the scope of this invention for a transaction to include, but not be limited to, a sale of the item during a date that is prior to or precedes the expiration date of the item, a donation of the item during a date that is prior to the expiration date of the item, or a return of the item to a manufacturer during a date that is prior to the expiration date of the item.

In another embodiment, the packaging of the item has a bar code. The expiration date is in communication with the barcode of the packaging.

In another embodiment a method of monitoring the expiration date of an item to enable processing of the item prior to the expiration date of the item has a label or packaging with an expiration date located thereon. The method has the steps of providing an item having a label with a first date located thereon. The first date is an expiration date of the item, whereby, the first date of the item is in electronic communication with a database. The expiration date is in electrical communication with a database when the expiration date is incorporated into including, but not limited to, a GS1 DataBar Expanded bar code. The database of expiration dates is in communication with the novel expiration date monitoring application program. Thus, the novel application program can automatically import expiration date data of an item, which is referred to as the first date.

In an alternate embodiment, the application program is in electrical communication with the database. This allows the expiration dates to be imported into the application program automatically and without requiring a user to manually enter in the first date data, which is the expiration date of the item. The novel expiration date monitoring application program is capable of comparing the first date of the item with a predetermined second date. The second date is a predetermined date preceding the first date, whereby, a user considers the amount of time needed for the specific item to allow for a transaction to occur before the item's expiration date. The novel application program is provided with the second date. A user will need to manually input the predetermined date into the application program. However, the item may be associated with a category type such as including, but not limited to, perishable food, canned goods, drugs, or frozen food, whereby, each item corresponds with a category with a preset, predetermined second date. Thus, allowing a user to input the category type rather than the second date for each item. This prepopulating of date information into the application program may save time.

### BRIEF DESCRIPTION OF THE DRAWINGS

For a fuller understanding of the nature and objects of the invention, reference should be made to the following detailed description, taken in connection with the accompanying drawings, in which:

FIG. 1 is a flow chart representing the operations performed by the by the novel expiration date monitoring system having manual input entry by a user into the application program by an electronic device;

FIG. 2 is a flow chart representing the operations performed by the by the novel expiration date monitoring system; and,

FIG. 3 is a flow chart representing an alternate embodiment of the operations performed by the novel expiration date monitoring system in which the first date of the item is in electronic communication with a database enabling the input data to be automatically transferred to the application program.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

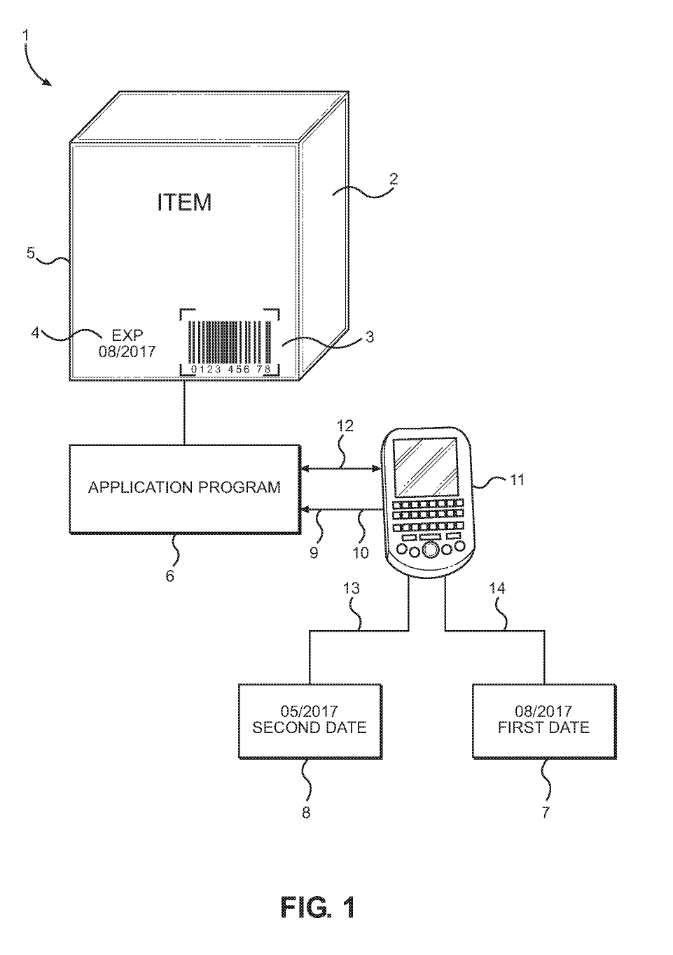

In a general embodiment as depicted in FIG. 1, the novel monitoring system 1 monitors expiration date 4 of item 5 to enable processing of item 5 prior to expiration date 4 of item 5. Item 5 is provided and has packaging 2 having expiration date 4 located thereon. In this embodiment, expiration date 4 is not in communication with barcode 3. Many manufacturers do not utilize bar codes that retain expiration date information such as the GS1 DataBar Expanded bar codes. Thus, expiration date 4 is not associated with standard barcode 3 and expiration date 4 input 7 needs to be manually entered 14 into application program 6 by electronic device 11. Application program 6 is in electrical communication 12 with electronic device 11. Electrical communication includes, but is not limited to, a wired connection or a wireless connection.

Application program 6 is adapted to receive input 13 and 14 by a user (not shown) through electronic device 11. First date 7 is input 14 into electronic device 11. Application program 6 is provided 9 first date 7, whereby, first date 7 is the same date as expiration date 4 of item 5. Second date 8 is input 13 into electronic device 11. Application program 6 is provided 10 second date 8, whereby, second date 8 is a predetermined date that precedes first date 7 of item 5.

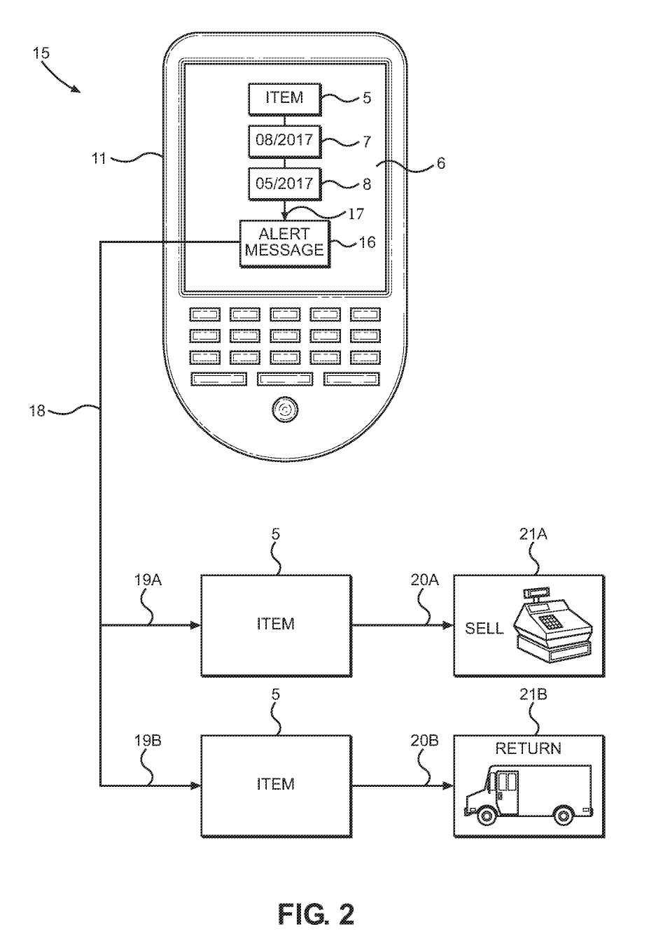

FIG. 2 illustrates electronic device 11. Application program 6 can be accessed through electronic device 11 for product monitoring 15. Application program 6 can display to a user item 5, first date 7, second date 8, and alert message 16. The application program 6 generates 17 an alert message 16 when second date 8 is met. Alert message 16 is generated and made visible to a user through the graphical user interface of an electronic device 11. In a first embodiment, once a user detects 18 alert message 16 the user processes 19A item 5. It is within the scope of this invention for processing of a transaction 20A to include, but not be limited to, physically relocating an item in a retail environment, re-shelving an item to a better location for a quick sell, prioritizing the item to be the subsequent item sold, having the item be associated with an aggressive marketing campaign, or reducing the cost of the item for a quick sell. In this embodiment, the item 5 is processed for a transaction 20A, whereby, the transaction results in a point-of sale transaction 21A or a donation.

FIG. 2 illustrates a second embodiment of processing 19B an item once a user detects 18 alert message 16. The user processes 19B item 5. It is within the scope of this invention for processing for a transaction 20B to include, but not be limited to, repackaging an item to be returned to a manufacturer or processing the unsold item to be returned to its point of origin. In this second embodiment, the item 5 is processed for a transaction 20B, whereby, the transaction results in a return back 21B to its origin, manufacturer, or supplier prior to the expiration date 7 or first date 7 of item 5.

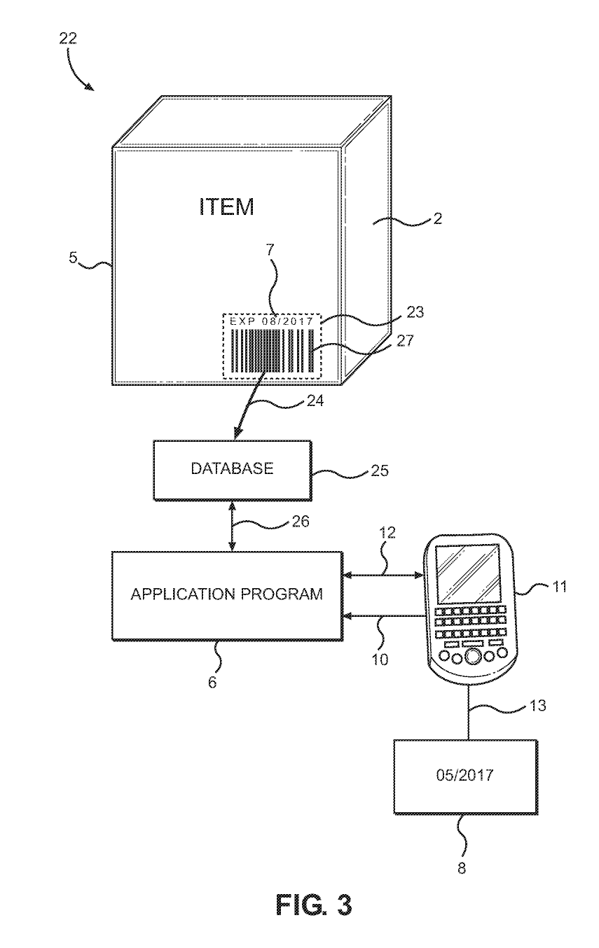

FIG. 3 illustrates another embodiment of the novel expiration date monitoring system 22. It is within the scope of this invention for item 5 to have a label 23 (FIG. 3) connected to packaging 2 of item 5. It is also within the scope of this invention for item 5 to have a label 23 (FIG. 3) connected directly to item 5 (not shown). Label 23 is capable of retaining barcode 27 having expiration date 7 data. First date 7 is in electrical communication 24 with database 25. Database 25 retains item expiration date data 7. Database 25 is in electrical communication 26 with application program 6. Application program 6 is in electrical communication 12 with electronic device 11. Second date 8 is inputted 10 into application program 6 through 13 electronic device 11. In this embodiment the user only needs to input the predetermined second date 8 because the expiration is incorporated with including, but not limited to, a GS1 barcode and expiration date 7 data is automatically communicated to database 25. In this embodiment, the second date 8 is monitored the same way as in the first embodiment as illustrated in FIG. 2.

It will be seen that the advantages set forth above, and those made apparent from the foregoing description, are efficiently attained and since certain changes may be made in the above construction without departing from the scope of this invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

1. A method of monitoring the expiration date of an item to enable processing of the item prior to the expiration date of the item, the item comprising packaging having an expiration date located thereon, said method comprising the steps of:
providing an item comprising packaging having an expiration date located thereon;
providing an application program in electrical communication with an electronic device, said application program is adapted to receive input by a user through said electronic device, said application program being capable of comparing said expiration date of said item with a predetermined date preceding said expiration date;
providing said application program with a first date, said first date being said expiration date of said item, whereby, said input is said first date;
providing said application program with a second date, said second date is said predetermined date that precedes said first date of said item, said predetermined date is configured to be determined by a user, said input is said second date;
monitoring said second date of said item, whereby, said application program is configured to be accessed by said user through said electronic device;
generating an alert message by said application program when said second date is met, whereby, said alert message is configured to indicate to said user when said second date is met;
detecting said alert message;
prompting the processing of said item when said alert message is detected, whereby, said alert message is adapted to urge said user to move said item from inventory prior to said first date of said item; and,
processing said item prior to said first date of said item, whereby, said item is associated with a transaction prior to said first date of said item.

2. The method of claim 1, wherein: said packaging of said item having a bar code, whereby, said expiration date is in communication with said barcode of said packaging.

3. The method of claim 1, wherein: said transaction of said item is a sale of said item during a date that is prior to said expiration date of said item.

4. The method of claim 1, wherein: said transaction of said item is a return of said item to a manufacturer during a date that is prior to said expiration date of said item.

5. A method of monitoring the expiration date of an item to enable processing of the item prior to the expiration date of the item, the item comprising a label with an expiration date located thereon, said method comprising the steps of:
providing a monitoring system using an application program accessible to a user through an electronic device having a graphical user interface, wherein a database of said application program receives an expiration date inputted into said database of said application program by a user, wherein, said expiration date is of an item comprising a label having a first date located thereon, wherein, said first date being said expiration date of said item;
receiving, by said application program of said monitoring system, by a user, a second date being a predetermined date preceding said first date;
comparing, by said application program of said monitoring system, said first date with said second date;
determining, with said application program of said monitoring system, that said second date is met;
generating, by said application program of said monitoring system, a stimulus, said stimulus being an alert message activated when said second date is met, whereby, said alert message indicates to said user when said second date is met;
detecting, with said application program of said monitoring system, said alert message by a user, wherein said alert message being displayed on a status page of said graphical user interface of said electronic device; and,
causing, by said application program of said monitoring system, the processing said item prior to said first date of said item by said user, wherein, said item is associated with a transaction prior to said first date of said item.

6.-14. (canceled)
